(19) United States
(12) Patent Application Publication
(10) Pub. No.: US 2004/0079477 A1
(43) Pub. Date: Apr. 29, 2004

(54) Method of making an interior trim part

(75) Inventors: Randall A. Gage, Troy, MI (US); Sunil K. Gupte, Livonia, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/280,321

(22) Filed: Oct. 25, 2002

(51) Int. Cl. B29C 47/00

(52) U.S. Cl. 156/245; 156/305

(57) ABSTRACT

A method of making an interior trim part, in accordance with the invention, includes the steps of applying a thermoset adhesive on a main body; preheating the main body after applying the adhesive on the main body; sufficiently inhibiting curing of the adhesive such that the preheated main body may be further heated and formed in a molding operation; applying a catalyst on the main body, the catalyst being configured to facilitate curing of the adhesive; and forming the main body in a heated mold to achieve a desired shape, wherein the mold sufficiently heats the adhesive and the catalyst to thereby enable sufficient curing of the adhesive.

### BACKGROUND OF THE INVENTION

1. Field of the Invention

The invention relates to a method of making a vehicle interior trim part using a thermoset adhesive.

2. Background Art

A prior method of making a vehicle interior trim part, such as a headliner, includes roll-coating a thermoset adhesive onto top and bottom surfaces of a foam core. A scrim layer including glass fibers and a catalyst sprayed on the glass fibers is then added to the bottom surface of the foam core. Next, a catalyst is sprayed onto the top surface of the foam core, followed by deposition of a top layer of glass fibers. An adhesive film and cover material are then positioned on the top layer of glass fibers. This composite stack is then positioned into a heated mold, where the composite stack is heated and molded into a desired shape.

Because heating of the composite stack occurs inside the mold, it may be difficult to sufficiently soften the composite stack prior to molding the composite stack. Thus, tearing or ripping of the composite stack may occur during the molding process.

### SUMMARY OF THE INVENTION

Under the invention, a method of making an interior trim part is provided. The method includes the steps of applying a thermoset adhesive on a main body; preheating the main body after applying the adhesive on the main body; sufficiently inhibiting curing of the adhesive such that the preheated main body may be further heated and formed in a molding operation; applying a catalyst on the main body, the catalyst being configured to facilitate curing of the adhesive; and forming the main body in a heated mold to achieve a desired shape, wherein the mold sufficiently heats the adhesive and the catalyst to thereby enable sufficient curing of the adhesive.

### BRIEF DESCRIPTION OF THE DRAWINGS

FIG. 1 is a schematic view of a production line arrangement for manufacturing an interior trim part, such as a headliner, according to the invention; and

FIG. 2 is a schematic view of a second embodiment of the production line arrangement for manufacturing an interior trim part, such as a headliner.

### DETAILED DESCRIPTION OF THE PREFERRED EMBODIMENT(S)

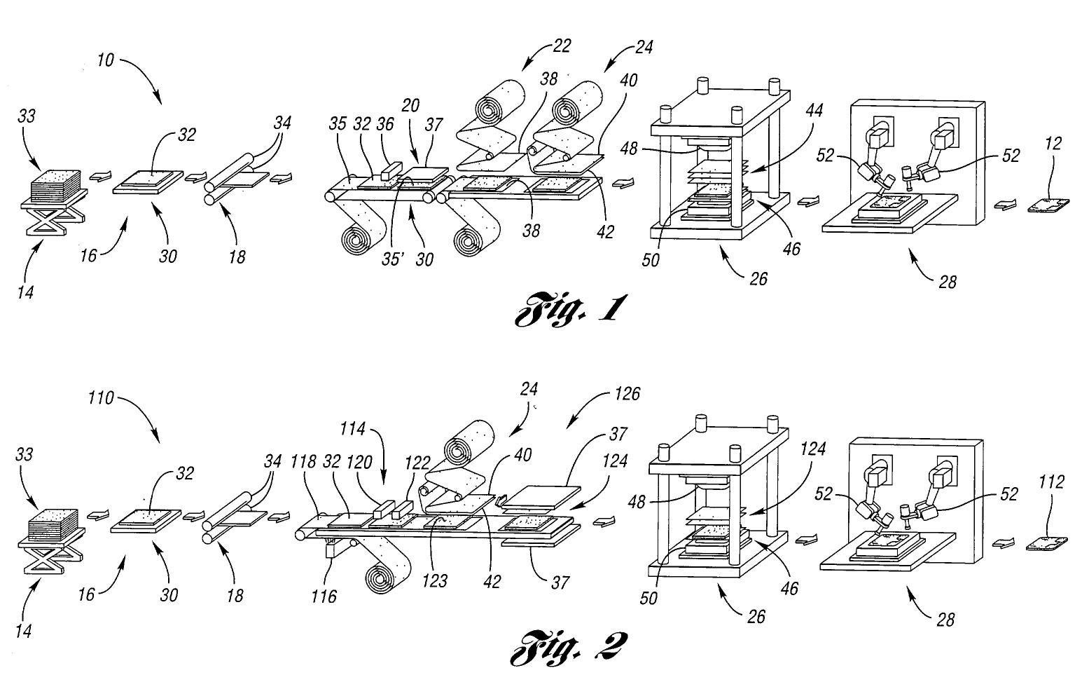

FIG. 1 shows a first embodiment of a system or production line arrangement 10, according to the invention, for manufacturing a vehicle interior trim part, such as a headliner 12 that is mountable adjacent a roof of a motor vehicle (not shown). The production line arrangement 10 includes a component staging or storage area 14, a loading station 16, an adhesive application station 18, a preheating station 20, a catalyst application station 22, a cover application station 24, a forming station 26 and a cutting station 28. The production-line arrangement 10 further includes a conveyor system 30 that may include one or more conveyors, such as belt conveyors, for transporting components between two or more of the stations 16-28.

A method according to the invention of manufacturing the headliner 12 using the production line arrangement 10, for example, will now be described in detail. First, a main body or core, such as a blank 32, is selected from the component storage area 14, which includes a source 33 of blanks 32. The blank 32 may comprise any suitable material and may be formed in any suitable manner. For example, the blank 32 may comprise a foam core, such as a urethane, polypropylene or polyester foam core. For the headliner 12, the blank 32 may also be referred to as a headliner body.

At loading station 16, the blank 32 is positioned on the conveyor system 30. The blank 32 is then transferred by the conveyor system 30 to the adhesive application station 18. While the adhesive application station 18 may include any suitable apparatus for applying a thermoset adhesive, in the embodiment shown in FIG. 1, the adhesive application station 18 includes a pair of rollers 34 that roll-coat thermoset adhesive onto top and bottom surfaces of the blank 32 to form adhesive layers on the blank 32. Alternative apparatuses for applying adhesive include spray applicators and brush applicators, for example. As yet another alternative, the adhesive may be provided as one or more thin films that are positioned on the blank 32. Furthermore, the adhesive may be any suitable thermosetting adhesive, such as a two component adhesive that includes polyol and isocyanate.

The production line arrangement 10 may also include means for applying reinforcing material, such as one or more reinforcing layers, onto the blank 32. For example, a fiber glass mat 35 from a fiber glass mat roll may be applied on the bottom surface of the blank 32. In addition or as an alternative, chopped glass fibers may be deposited on the top surface of the blank 32 to form a fiberglass layer 35′. The glass fibers may be deposited by a deposit head or spray head 36, for example.

Next, the blank 32 is transferred to the preheating station 20, where the blank 32 is preheated to sufficiently soften the blank 32 in order to prepare the blank 32 for a subsequent molding operation. The preheating station 20 includes one or more heaters 37 positioned above and/or below the blank 32. Each heater 37 may be any suitable device, such as an infra-red heater, radiant heater and/or convective heater. Furthermore, the heaters 37 may be used to preheat the blank 32 to any suitable temperature, such as a temperature in the range of 50 to 100 degrees Celsius.

After sufficient heating, the blank 32 is transferred by the conveyor system 30 to the catalyst application station 22, where a catalyst is applied on the the blank 32. More specifically, in the embodiment shown in FIG. 1, the catalyst is applied on the reinforcing layers 35, 35′, which are positioned on the adhesive applied to the top and bottom surfaces of the blank 32. Furthermore, the catalyst is configured to diffuse through the reinforcing layers 35, 35′ so as to make contact with the adhesive.

The catalyst may comprise any suitable substance that is configured to facilitate curing of the adhesive when the blank 32 is subsequently sufficiently heated. For example, the catalyst may comprise mercury, bismuth, tin, sulphur, an amine, or any combination thereof. Furthermore, the catalyst may be applied in any suitable manner. For example, catalyst bearing layers, such as scrim layers 38, may be applied on the top and bottom surfaces of the blank 32, which surfaces have the adhesive and the reinforcing layers 35, 35′ applied thereon. Each scrim layer 38 may be any suitable layer, such as a barrier layer, support layer and/or reinforcing layer, and may include any suitable material. For example, each scrim layer 38 may include a thermoplastic film and/or reinforcing material, such as glass fibers and/or other reinforcing fibers, as well as catalyst material combined with the film and/or reinforcing material. With such a configuration, the catalyst diffuses from the scrim layers 38 to the adhesive on the blank 32. Alternatively or supplementally, the catalyst application station 22 may include one or more applicators, such as deposit or spray heads (not shown), for spraying or otherwise applying catalyst onto the top and bottom surfaces of the blank 32, or onto scrim layers or other layers that are subsequently applied on the blank 32.

At the cover application station 24, a cover layer or cover material 40 may be positioned proximate the top surface of the blank 32, if desired. In the embodiment shown in FIG. 1, the cover material 40 is positioned over the scrim layer 38. The cover material 40 may comprise any suitable material, such as woven or non-woven fabric, including nylon or polyester fabric, that is provided with or without a backing, such as a foam backing. Furthermore, the cover material 40, if used, is configured to form an appearance surface of the finished headliner 12. Thus, the top surface of the blank 32 shown in FIG. 1 actually faces downwardly when the headliner 12 is installed in a vehicle. A suitable adhesive, such as an adhesive film 42, may also be positioned between the cover material 40 and the blank 32. Furthermore, the adhesive film 42 may be used to apply the catalyst described above in detail. For example, the catalyst may be integrally formed with the adhesive film 42, or applied onto the adhesive film 42 such as by a spraying operation.

Next, the blank 32 and other layers or components 35, 35′, 38, 40 and 42, which may collectively be referred to as a composite stack 44, are transferred to the forming station 26. Preferably, but not necessarily, the cover application station 40 is positioned immediately adjacent the forming station 26 so that the composite stack 44 may be transferred quickly from the cover application station 40 to the forming station 26. Although, for clarity purposes, some of the components 32, 35, 35′, 38, 40 and 42 are shown spaced apart from each other at the forming station 26, in practice, the components 32, 35, 35′, 38, 40 and 42 may be in contact with each other to form the composite stack 44. It is to be understood that if the components 32, 35, 38, 40 and 42 are provided from rolls, then suitable cutting operations may be performed prior to the forming station 26 to thereby form the composite stack 44. Furthermore, one or more of the components 35, 35′, 38, 40 and 42 may be omitted if not desired or required for a particular application.

The forming station 26 includes a heated mold 46 having first and second mold portions 48 and 50, respectively. One or both of the mold portions 48 and 50 may be heated in any suitable manner such that the mold 46 is capable of heating the composite stack 44 to or above an activation temperature of the catalyst applied on the blank 32. The activation temperature of the catalyst is the temperature at which the catalyst vigorously reacts with the adhesive, thereby accelerating curing of the adhesive. For example, the mold 46 may be configured to heat the composite stack 44 to a temperature above 130 degrees Celsius.

The mold 46 is movable between an open position, shown in FIG. 1, and a closed position (not shown). In the embodiment shown in FIG. 1, each mold portion 48 and 50 has a non-planar, contoured mold surface. Alternatively, one or both of the mold portions 48 and 50 may have a flat or planar mold surface. When the mold 46 is in the closed position, the mold surfaces cooperate with each other to mold or form the composite stack 44 into a desired shape or contour. Furthermore, after sufficient curing, the adhesive solidifies so as to maintain the blank 32 and the remainder of the composite stack 44 in the desired shape.

The molded composite stack 44 is then transferred to the cutting station 28, where the composite stack 44 is trimmed to the final shape of the headlliner 12. While the cutting station 28 may include any suitable cutting apparatus for trimming the headliner 12, in the embodiment shown in FIG. 1, the cutting station 28 includes one or more water jets 52. Alternative cutting apparatuses include, for example, knives and laser cutters.

With the above described production line arrangement 10 and method, because the catalyst is applied on the blank 32 after preheating of the blank 32, curing of the adhesive may be sufficiently inhibited such that the blank 32 can be further heated and formed in the mold 46, or in some other molding operation. Furthermore, because of the preheating step, the blank 32 may be sufficiently softened such that the blank 32 may be more easily formed or molded, as compared with prior processes that utilize thermoset adhesives but don't include a preheating step. As a result, the headliner 12, or other interior trim part, may be formed with significant contours or surface features, such as deep recesses and curved edges, without ripping or tearing the blank 32. Furthermore, the blank 32 may comprise more rigid materials, thereby providing significant strength and rigidity to the headliner 12.

Referring to FIG. 2, a second embodiment 110 of the production line arrangement is shown for forming an interior trim part, such as a headliner 112, according to the invention. The production line arrangement 110 includes many of the same or similar elements as the production line arrangement 10, and those elements are identified with the same reference numbers as used in FIG. 1. With the production line arrangement 110, however, curing of adhesive is inhibited in an alternate manner as described below in detail.

Similar to the method described above, with the production line arrangement 110, a main body or core, such as a blank 32 selected from a source of blanks, is positioned on conveyor system 30 at loading station 16. The blank 32 is then transferred to adhesive application station 18. At adhesive application station 18, a thermoset adhesive, such as an adhesive that includes polyol and isocyanate, is applied on the blank 32, in a similar manner as described above in detail, to form adhesive layers on the blank 32. With the production line arrangement 110, however, the adhesive may also be provided with a blocking agent, such as a chemical blocking agent, that is configured to inhibit curing of the adhesive until the adhesive is heated to a sufficient molding temperature. In the embodiment shown in FIG. 2, the blocking agent is combined with the adhesive or a component of the adhesive to form an adhesive-blocking agent combination, and the blocking agent and adhesive are applied simultaneously onto the blank 32, such as with rollers 34. Alternatively, the blocking agent may be applied prior to and/or after application of the adhesive. For example, the production line arrangement 110 may include a spray head (not shown) for applying the blocking agent onto top and bottom surfaces of the blank 32 after application of the adhesive.

The blocking agent may comprise any suitable substance that is configured to sufficiently inhibit curing of the adhesive, even with a catalyst applied on and/or with the adhesive, such that the blank 32 may be preheated to a temperature below the molding temperature without causing significant curing of the adhesive. In one embodiment of the invention, the blocking agent may be configured as an adhesive blocking agent that inhibits interaction of adhesive components, and/or a catalyst blocking agent that inhibits interaction of the adhesive with a catalyst that is applied on and/or with the adhesive. For example, the blocking agent may comprise monoamines, diamines, triamines, polyamines and/or oligomers that are chemically bonded or attached to isocyanates in the adhesive-blocking agent combination. Below a predetermined adhesive activation temperature, which may be varied based on the blocking agent selected for a particular application, the blocking agent remains attached to the isocyanates and “blocks” the isocyanates from reacting with polyols in the adhesive-blocking agent combination. Upon heating to the molding temperature, which is at or above the adhesive activation temperature, the blocking agent dissociates from the isocyanate groups, which may then react with the polyols to form polyurethane. Examples of amine-blocked polyisocyanates are disclosed in U.S. Pat. No. 5,961,878, which is hereby incorporated by reference in its entirety.

Next, the blank 32 is transferred to catalyst application station 114, where a catalyst is applied on the top and bottom surfaces of the blank 32, which surfaces have the adhesive and blocking agent applied thereon. The catalyst may be any suitable catalyst, such as one or more of the catalysts described above, and may be applied in any suitable manner, such as described above with respect to the production line arrangement 10. In the embodiment shown in FIG. 2 for example, the catalyst application station 114 includes a catalyst applicator, such as spray head 116, that applies catalyst onto a separate layer, such as scrim layer 118, which is then applied onto the bottom surface of the blank 32. As with the scrim layer 38, scrim layer 118 may be any suitable layer, such as a barrier layer, support layer and/or reinforcing layer, and may include any suitable material, such as described above with respect to the scrim layer 38. As another example, catalyst may be applied on a reinforcing layer similar to the reinforcing layer 35 described above, and a separate scrim layer may also be positioned beneath the reinforcing layer.

In the embodiment shown in FIG. 2, the catalyst application station 114 also includes an additional catalyst spray head 120 for spraying catalyst onto the top surface of the blank 32. Furthermore, the production line arrangement 110 may include a deposit head or spray head 122 for applying reinforcing material, such as chopped glass fibers, onto the top surface of the blank 32 to form a reinforcing layer 123.

Alternatively or supplementally, the catalyst may be applied with the adhesive and/or the blocking agent. For example, the catalyst may be premixed or otherwise combined with the adhesive and/or blocking agent, and the combination may be applied onto the blank 32 in any suitable manner. Furthermore, the catalyst may include the blocking agent. In such a case, the blocking agent may be referred to as a catalyst blocking agent, and the catalyst may be referred to as a delayed action catalyst that does not vigorously react with the adhesive until the catalyst is heated to or above an activation temperature of the catalyst. An example of such a catalyst includes salts of a tertiary amine and a carboxylic acid, such as formic acid and/or acetic acid. The salts themselves are not catalytically active, until they dissociate into amine radicals at the activation temperature of the catalyst.

As yet another alternative, the catalyst may be applied on the blank 32 prior to application of the adhesive and/or blocking agent. For example, the catalyst may be sprayed or otherwise applied directly on the blank 32.

The blank 32 is then transferred to cover application station 24, where a cover material 40 may be positioned proximate the top surface of the blank 32, if desired. As described above, the cover material 40 may comprise any suitable material, and is configured to form an appearance surface of the finished headliner 112. A suitable adhesive, such as an adhesive film 42 may also be positioned between the cover material 40 and the blank 32.

Next, the blank 32 and other layers or components 118, 123, 40 and 42, which may collectively be referred to as a composite stack 124, are then transferred to preheating station 126. Although, for clarity purposes, some of the components 32, 118, 123, 40 and 42 are shown spaced apart from each other at the preheating station 126, in practice, the components 32, 118, 123, 40 and 42 may be in contact with each other to form the composite stack 124. Furthermore, one or more of the components 118, 123, 40 and 42 may be omitted if not desired or required for a particular application.

At the preheating station 126, the composite stack 124 is preheated to a temperature below the molding temperature. More specifically, in this example, the composite stack 124 is preheated to a temperature below the activation temperature of the adhesive and/or the activation temperature of the catalyst. As with the preheating station 20, the preheating station 126 is configured to sufficiently preheat the blank 32, as well as the other components of the composite stack 124, so as to sufficiently soften the blank 32 for a subsequent molding operation. Similar to the preheating station 20, the preheating station 126 includes one or more heaters 37 positioned above and/or below the blank 32. Each heater 37 may be any suitable device, such as an infra-red heater, radiant heater and/or convective heater. Furthermore, the heaters 37 may be used to preheat the blank 32, as well as the other components of the composite stack 124, to any suitable temperature, such as a temperature in the range of 50 to 100 degrees Celsius.

The composite stack 124 is then transferred to the forming station 26, where mold 46 is used to mold or form the composite stack 124 into a desired contour. In a similar manner as described above, the mold 46 is also used to heat the composite stack 124 to the molding temperature, which is at least as great as the activation temperature of the adhesive (if the blocking agent is configured as an adhesive blocking agent) and/or the activation temperature of the catalyst (if the blocking agent is configured as a catalyst blocking agent). For example, the mold 46 may be configured to heat the composite stack 124 to a temperature above 130 degrees Celsius.

If the blocking agent is configured as an adhesive blocking agent, then the adhesive components may react with each other and with the catalyst when the composite stack 124 is sufficiently heated in the mold 46. If the blocking agent is configured as a catalyst blocking agent, then the catalyst may vigorously react with the adhesive when the composite stack 124 is sufficiently heated, such that the catalyst accelerates curing of the adhesive. After sufficient curing, the adhesive cooperates with the blank 32 to maintain the headliner 112 in the desired shape.

The molded composite stack 124 is then transferred to the cutting station 28. At cutting station 28, the composite stack 124 is trimmed to the final shape of the headlliner 112 in a similar manner as described above in detail.

Because the blocking agent sufficiently inhibits curing of the adhesive applied on the blank 32, the blank 32 may be preheated prior to molding, without causing significant curing of the adhesive. Thus, the production line arrangement 110 and associated method enable the headliner 112, or other interior trim part, to be formed with significant contours or surface features, and without ripping or tearing the blank 32.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, the above described production line arrangements and methods may be used to make any suitable interior trim part, such as a package tray or a flooring system. Furthermore, although specific production line arrangements are described above in detail, it is to be understood that any suitable system or production line arrangement may be used to manufacture an interior trim part according to the method of the invention.

What is claimed is:

1. A method of making a vehicle interior trim part, the method comprising:
applying a thermoset adhesive on a main body;
preheating the main body after applying the adhesive on the main body;
sufficiently inhibiting curing of the adhesive such that the preheated main body may be further heated and formed in a molding operation;
applying a catalyst on the main body, the catalyst being configured to facilitate curing of the adhesive; and
forming the main body in a heated mold to achieve a desired shape, wherein the mold sufficiently heats the adhesive and the catalyst to thereby enable sufficient curing of the adhesive.

2. The method of claim 1 wherein the step of sufficiently inhibiting curing of the adhesive comprises performing the step of applying the catalyst on the main body after the step of preheating the main body.

3. The method of claim 2 wherein the step of applying the catalyst comprises spraying the catalyst onto the main body.

4. The method of claim 2 wherein the step of applying the catalyst comprises applying a reinforcing layer on the main body, the reinforcing layer including the catalyst.

5. The method of claim 1 wherein the step of sufficiently inhibiting curing of the adhesive comprises applying a blocking agent on the main body, the blocking agent being configured to inhibit curing of the adhesive.

6. The method of claim 5 wherein the blocking agent comprises a salt of a tertiary amine.

7. The method of claim 5 wherein the blocking agent is applied on the main body prior to the step of applying the catalyst.

8. The method of claim 5 wherein the catalyst includes the blocking agent, and the step of applying the catalyst and the step of applying the blocking agent are performed simultaneously.

9. The method of claim 5 wherein the blocking agent and the adhesive are combined together and applied on the main body simultaneously.

10. The method of claim 9 wherein the catalyst is applied simultaneously with the blocking agent and the adhesive.

11. The method of claim 1 wherein the step of preheating the main body comprises preheating the main body to a temperature in the range of 50 to 100 degrees Celsius.

12. The method of claim 11 wherein the heated mold includes a mold surface that is heated to at least 130 degrees Celsius.

13. The method of claim 1 wherein the catalyst comprises an amine.

14. The method of claim 1 wherein the catalyst comprises mercury.

15. The method of claim 1 wherein the catalyst comprises bismuth.

16. The method of claim 1 wherein the step of applying the catalyst comprises positioning an adhesive film including the catalyst proximate the main body.

17. The method of claim 16 further comprising positioning a cover layer proximate the main body such that the adhesive film is disposed between the main body and the cover layer.

18. A method of making a headliner, the method comprising:
roll-coating a thermoset adhesive on a foam core;
preheating the foam core to a temperature in the range of 50 to 100 degrees Celsius after roll-coating the adhesive on the foam core;
applying a catalyst on the preheated foam core, the catalyst being configured to facilitate curing of the adhesive when the foam core is subsequently sufficiently heated; and
forming the foam core in a heated mold to achieve a desired shape, wherein the mold heats the adhesive and the catalyst to a temperature of at least 130 degrees Celsius to thereby enable sufficient curing of the adhesive.

19. A method of making a headliner, the method comprising:
roll-coating a thermoset adhesive on a foam core;
applying a catalyst on the foam core, the catalyst being configured to facilitate curing of the adhesive;
applying a blocking agent on the foam core, the blocking agent being configured to inhibit curing of the adhesive until the adhesive and the catalyst are heated to a molding temperature;
preheating the foam core after application of the blocking agent, such that the adhesive and the catalyst are heated to a first temperature below the molding temperature; and
forming the foam core in a heated mold to achieve a desired shape, wherein the mold heats the adhesive and the catalyst to a second temperature at least as great as the molding temperature to thereby enable sufficient curing of the adhesive.

20. The method of claim 19 wherein the blocking agent and the adhesive are combined together and applied on the foam core simultaneously.

21. The method of claim 20 wherein the catalyst is applied simultaneously with the blocking agent and the adhesive.
